(19) United States
(12) Patent Application Publication
(10) Pub. No.: US 2012/0166456 A1
(43) Pub. Date: Jun. 28, 2012

(54) METHOD AND APPARATUS FOR CREATING DATA TABLE OF FORENSICS DATA

(75) Inventors: Keonwoo KIM, Daejeon (KR); Do Won Hong, Daejeon (KR); Sung Kyong Un, Daejeon (KR); Youngsoo Kim, Daejeon (KR); Sang Su Lee, Daejeon (KR); Woo Yong Choi, Daejeon (KR); Jooyoung Lee, Daejeon (KR); Su Hyung Jo, Daejeon (KR); Youn-Hee Gil, Daejeon (KR); Hyun sook Cho, Daejeon (KR)

(73) Assignee: Electronics and Telecommunications Research Institute, Daejeon (KR)

(21) Appl. No.: 13/338,147

(22) Filed: Dec. 27, 2011

(30) Foreign Application Priority Data
Dec. 27, 2010 (KR) 10-2010-0135730

(51) Int. Cl. G06F 17/30

(52) U.S. Cl. 707/754; 707/755; 707/E17.059

(57) ABSTRACT

An apparatus for creating a data table of a forensic data, includes a data parser configured to create primary data tables including unique attributes of the predetermined keywords by parsing the raw data having different formats for each forensics tool, each attribute having a unique standardized format. The apparatus further includes a data filter filtering specific fields or attributes from the primary data tables to newly create secondary data table. The apparatus further includes a data relation analyzer analyzing a relation between the data within the primary data tables to newly create secondary data tables.

### CROSS-REFERENCE(S) TO RELATED APPLICATION(S)

The present invention claims priority of Korean Patent Application No. 10-2010-0135730, filed on Dec. 27, 2010, which is incorporated herein by reference.

### FIELD OF THE INVENTION

The present invention relates to a data table of a forensics data, and more particularly, to a method and an apparatus for creating a data table of a forensics data used to visualize or view data collected from a live data forensics tool or a portable forensics tool to a user.

### BACKGROUND OF THE INVENTION

As known, a computer forensics tool is used to collect data from a computer, analyze the collected data, and view the analyzed data to a user. In particular, a live data forensics tool or a portable forensics tool is employed to collect and analyze data from a computer within a rapid time without performing an imaging process in a scene of crime or when there is a need to rapidly collect data.

An example of the data collectable from the live data forensics tool or the portable forensics tool may include system start/end recording data, web visit/search/account recording data, USB connect recording data, processor execution recording data, command execution recording data, file search recording data, messenger recording data, document creation/modification/deletion recording data, file creation/modification/deletion recording data, network information data such IP address, or the like, user information data such as log-in account, or the like, system information data, such as operating system version, disk information, or the like, registry data, or the like.

Meanwhile, raw data that may be collected from the live data forensics tool or the portable forensics tool have unique types for each tool. Further, the raw data are not defined in a single format and thus, methods for representing the collected data are also different from each tool.

A work of upgrading the raw data so that the raw data may be seen to the user as intuitive and efficient information by analyzing, integrating and systematizing the raw data is referred to as the data visualization or the data view. Generally, the data visualization may be conducted by sequentially performing processes of the raw data collection, a data table creation through data transformation, a visual structure creation through visual mapping, and a view process through view transformation.

The data visualization or data view method by most of the live data forensics tools or the portable forensics tools in accordance with the related art uses a method of simply arranging data. For example, a method of representing document access recording is performed by arranging the access time and paths over the access time by all of the text methods. Similarly, a method of web access recording is performed by listing visiting hours and visiting web pages for all the accesses one by one. In particularly, when the user wants to represent only specific date or specific keywords, the existing tool cannot originally show the user the specific date or the specific keywords. In addition, when a large amount of data is collected, the data shown to the user are merely repeated in the same pattern. Therefore, the user has failed to search the desired data and it is difficult for the user to perform an efficient analysis.

### SUMMARY OF THE INVENTION

In view of the above, the present invention provides a method for configuring various data tables from raw data collected for portable forensics data visualization.

In accordance with an aspect of the present invention, there is provided an apparatus for creating a data table of a forensic data, the apparatus including:

a data parser configured to create primary data tables including unique attributes of the predetermined keywords by parsing the raw data having different formats for each forensics tool, each attribute having a unique standardized format.

Preferably, the apparatus further includes a data filter configured to filter specific fields or attributes from the primary data tables to newly create secondary data table.

Preferably, the apparatus further includes a data relation analyzer configured to analyse a relation between the data within the primary data tables to newly create secondary data tables.

In accordance with another aspect of the present invention, there is provided a method for creating a data table of a forensic data, the method including:

generating primary data tables including unique attributes of the predetermined keywords by parsing the raw data having different formats for each forensics tool, each attribute having a unique standardized format.

Preferably, the method further includes filtering specific fields or attributes from the primary data tables to newly create secondary data table.

Preferably, the method further includes analyzing a relation between the data from the primary data table to newly create secondary data table.

### BRIEF DESCRIPTION OF THE DRAWINGS

The above and other objects and features of the present invention will become apparent from the following description of embodiments given in conjunction with the accompanying drawings, in which:

FIG. 1 shows a block diagram of an apparatus for creating a data table used for forensics data visualization in accordance with an embodiment of the present invention;

FIG. 2 is a system start/end data table;

FIG. 3 is a web visit/search/account data table;

FIG. 4 is a USB connect data table;

FIG. 5 is a process execution data table;

FIG. 6 is a command execution data table;

FIG. 7 is a file search data table;

FIG. 8 is a messenger data table;

FIG. 9 is a document creation/modification/deletion data table;

FIG. 10 is a file creation/modification/deletion data table; and

FIG. 11 exemplarily illustrates a new data table created by selecting specific fields or attributes from at least one data table in accordance with the embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

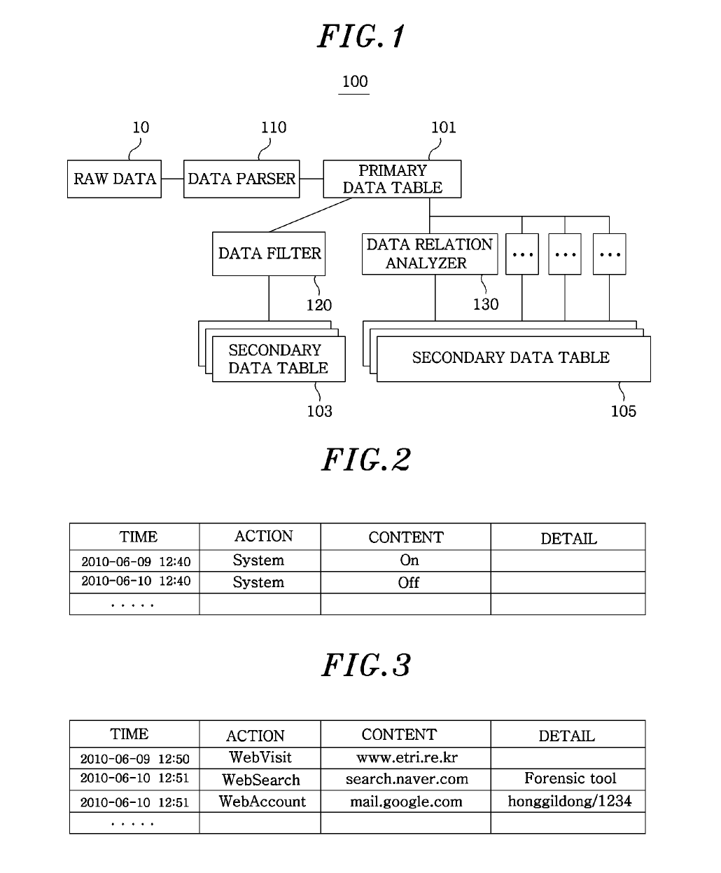

FIG. 1 is a block diagram of an apparatus for creating a data table used for forensics data visualization in accordance with an embodiment of the present invention.

As shown in FIG. 1, an apparatus 100 for creating a data table includes a data parser 110, a data filtering/collector 120, and a data relation analyzer 130.

The apparatus 100 for uses the raw data collected from the live data forensics tool or the portable forensics tool and converts the collected raw data into the data table used for the forensics data visualization.

An example of the raw data 10 may include start/end recording data, web visit/search/account recording data, USB connect recording data, processor execution recording data, command execution recording data, file search recording data, messenger recording data, document creation/modification/deletion recording data, and file creation/modification/deletion recording data, all of which are collected from the live data forensics tool or the portable forensics tool.

The portable forensics tool may collect other data, such as the network information, the system information, or the like, but is not appropriate for meaning visualization representation of the portable forensics data. However, similar to the raw data that is a target of the present invention, it is possible to create the data table. Further, the data output types for each portable forensics tool are different and therefore, if a portion of the raw data is not intended to output from the specific tool, the data table corresponding thereto is not created.

The data parser 110 serves to create primary data table101 configured by a plurality of attributes having predetermined keywords from the raw data having different formats for each live data forensics tool or each portable forensics tool. That is, the primary data table 101 including unique attributes of the predetermined keywords is created by parsing the raw data having different formats for each forensics tool, wherein each attribute has a unique standardized format.

For example, the keywords may be set as ‘time’, ‘action’, ‘content’, and ‘detail’. Such attribute keywords may be replaced with other keywords.

FIGS. 2 to 10 illustrate the primary data table 101 that may be created by allowing the data parser 110 to use each raw data.

In the primary data table 101 of FIGS. 2 to 10, the ‘time’ attribute may have a “yyy-mm-dd hh:mm” format. “2010-06-09 12:40” is the example. In some cases, there may be no a ‘time’ attribute value.

The ‘action’ attributes may each have keywords, such as ‘System’, ‘WebVisit/WebSearch/WebAccount’, ‘USB’, ‘Process’, ‘Command’, ‘FileSearch’, ‘Messenger’, ‘DocumentCreated/DocumentModified/DocumentDeleted’, ‘FileCreated/FileModified/FileDeleted’, or the like. The keywords indicating the ‘action’ attribute values may be replaced with other keywords having the same meaning.

The ‘content’ and ‘detail’ attributes according to the ‘action’ attributes are different for each data table.

FIG. 2 is a system start/end data table.

The system start/end data table as shown in FIG. 2 is created using the raw data having the system start/end recording. When the system is power on or power off, the system itself records the time information and other information. The portable forensics tools serve to collect the information. The data parser 110 configures a table as shown in FIG. 2 by parsing only the time information and on and off information among the raw data having various formats and recording information. The ‘time’ attribute value of FIG. 2 has the above-mentioned format as a time value when the system is turned on or turned off. The ‘action’ attribute value is defined by ‘system’. The ‘content’ attribute value is one of ‘on’ and ‘off’. There is no ‘detail’ attribute value of the system start/end data table.

FIG. 3 is a web visit/search/account data table.

The web visit/search/account data table as shown in FIG. 3 is created using the raw data having the web visit/search/account recording. When visiting a web page using a web browser, a system records visit time, a visit web page address (URL), and other information. In addition, when searching the web page, the system records the visit time, the search web page address (URL), the keywords, and other information. In addition, when logging-in the web page requiring the log-in, the system records the visit time, a log-in web page address, a log-in ID, a log-in password, and other information. The data parser 110 parses only the time information, the URL information, the keyword information, and the log-in ID and password information among the raw data having various formats and the recording information to configure the table as shown in FIG. 3. In the data table of FIG. 3, the ‘time’ attribute value has the above-mentioned format as a time value when performing the web visit, the search, and the log-in. In the case of the web visit, the ‘action’ attribute value is defined by ‘WebVisit’ and the ‘content’ attribute value is the ‘URL’ representing the visiting web address and has no ‘detail’ attribute value. In the case of the web search, the ‘action’ attribute value is defined by ‘WebSearch’ and the ‘content’ attribute value is the ‘URL’ representing the visiting web address and the ‘detail’ attribute value is a keyword. In the case of the web account, the ‘action’ attribute value is defined by ‘WebAccount’ and the ‘content’ attribute value is the ‘URL’ representing the logged-in web address and the ‘detail’ attribute value is ‘log-in ID/log-in password’. The log-in ID and password are identified into ‘/’ and are represented by ‘null’ when there are no ID and password. ‘kimlee/null’ is the example.

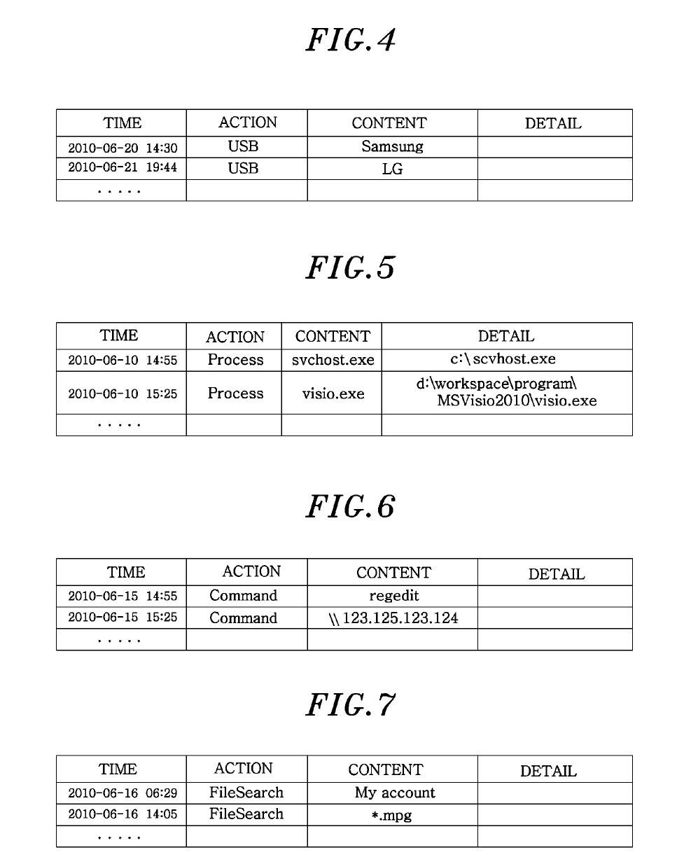

FIG. 4 is a USB connect data table.

The USB connect data table of FIG. 4 is created using the raw data having the USB connect recording. When an USB disk is connected to a system, the system records the access time, the USBS maker, a serial number, and other information. The portable forensics tools serves to collect the information. The data parser 110 configures a table as shown in FIG. 4 by parsing only the time information and maker information among the raw data having various formats and recording information. The ‘time’ attribute value of FIG. 4 has the above-mentioned format as a time value when the USB disk is connected to the system. The ‘action’ attribute value is defined by ‘USB’. The ‘content’ attribute value is a maker and there is no ‘detail’ attribute value.

FIG. 5 is a process execution data table.

The processor execution data table of FIG. 5 is created using the raw data having the processor execution recording. When any processor is executed, a system records the executed time, an executed processor name, an execution path, and other information. The portable forensics tools serve to collect the information. The data parser 110 configures a table as shown in FIG. 5 by parsing only the time information, the executed processor name, and the execution path among the raw data having various formats and recording information. The ‘time’ attribute value of FIG. 5 has the above-mentioned format as a time value when the processor is executed. The ‘action’ attribute value is defined by ‘Process’. The ‘content’ attribute value is the executed processor name and the ‘detail’ attribute value is the execution path. A directory of the execution path is identified by ‘\’ and there may be no path.

FIG. 6 is a command execution data table.

The command execution data table of FIG. 6 is created using the raw data having the command execution recording. When the command is issued to a system using a console program, or the like, the system records the executed time, the executed command, and other information. The portable forensics tools serves to collect the information. The data parser 110 configures a table as shown in FIG. 6 by parsing only the time information and the executed command information among the raw data having various formats and recording information. The ‘time’ attribute value of FIG. 6 has the above-mentioned format as a time value when the command is issued using the command. The ‘action’ attribute value is defined by ‘Command’. The ‘content’ attribute value is the executed command name and there is no ‘detail’ attribute value.

FIG. 7 is a file search data table.

The file search data table of FIG. 7 is created using the raw data having a file search recording. In order to search a file within a system, when a file name is input and a search command is issued, the system records the time, the keyword, and other information executing the search. The portable forensics tools serves to collect the information. The data parser 110 configures a table as shown in FIG. 7 by parsing only the time information and the keyword information among the raw data having various formats and recording information. The ‘time’ attribute value of FIG. 7 has the above-mentioned format as a time value when the search is executed. The ‘action’ attribute value is defined by ‘FileSearch’. The ‘content’ attribute value is a keyword and there is no ‘detail’ attribute value.

FIG. 8 is a messenger data table.

The messenger data table of FIG. 8 is created using the raw data having a messenger use recording. When conversing with the opponent using a messenger program that can transmit and receive an instant message, a system records conversation time, messenger type, one's own ID, one's own log-in password, the opponent's ID information, and other information. The portable forensics tools serve to collect the information. The data parser 110 configures a table as shown in FIG. 8 by parsing only the time information, the messenger type, one's own ID, one's own log-in password, the opponent's ID information among the raw data having various formats and recording information. The ‘time’ attribute value of FIG. 8 has the above-mentioned format as a time value when the conversation starts using the messenger. The ‘action’ attribute value is defined by ‘Messenger’. The ‘content’ attribute value is a used messenger type and the ‘detail’ attribute value is the ‘log-in ID/log-in password/opponent ID’. ‘honggd/ghdrlfehd/bangja80’ is the example. The identification in the ‘detail’ attribute value is identified by ‘/’ and is represented by null when there is no ID or password information.

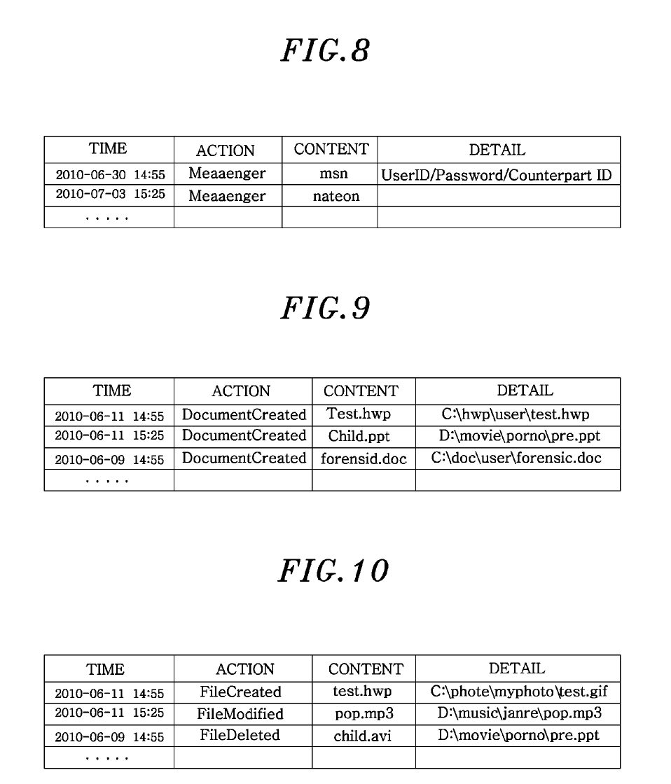

FIG. 9 is a document creation/modification/deletion data table.

The document creation/modification/deletion data table of FIG. 9 is created using the raw data having the document creation/modification/deletion recording. A document file such as a document for a word processor, a document for presentation, a document for a design, a text document is created and when the document file is modified or deleted, a system records the document creation/modification/deletion time and the path in which the document name and the document is positioned, and other information. The data parser 110 configures a data table as shown in FIG. 9 by parsing the document creation/modification/deletion time and the path in which the document name and the document are positioned among the raw data having various formats and recording information. In the data table of FIG. 9, the ‘time’ attribute value has the above-mentioned format as a time value when performing the document creation/modificn the case of the document creation, the ‘action’ attribute value is defined by ‘DocumentCreated’, in the case of the document modification, the ‘action’ attribute value is defined by ‘DocumentModified’, and in the case of the document deletion, the action ‘attribute value’ is defined by ‘DocumentDeleted’. The ‘contents’ attribute value is the created/modified/deleted document file name and the ‘detail’ attribute value is a path name in which the document file is positioned.

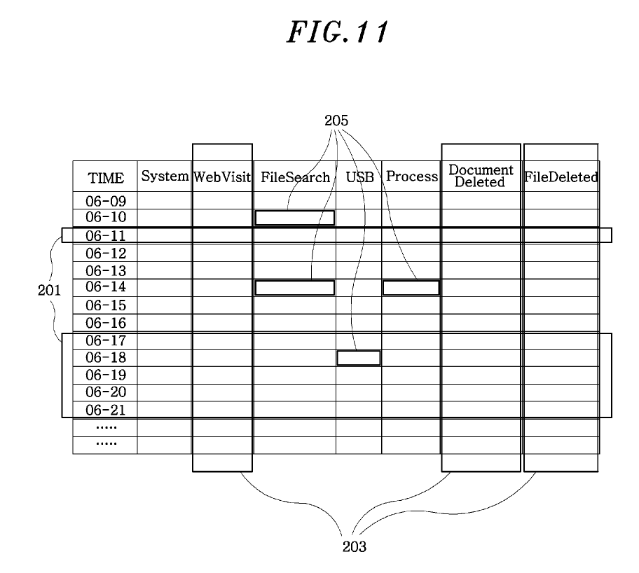

FIG. 10 is a file creation/modification/deletion data table.

The file creation/modification/deletion data table of FIG. 10 is created using the raw data having a file creation/modification/deletion recording. When creating a music file, a moving picture file, other general files other than a document file and modifying or deleting the same, a system records the file creation/modification/deletion time and the path in which the file name and the file are positioned, and other information. The data parser 110 configures a data table as shown in FIG. 10 by parsing the file creation/modification/deletion time and the path information in which the file name and the file are positioned among the raw data having various formats and recording information. In the data table of FIG. 10, the ‘time’ attribute value has the above-mentioned format as a time value when performing the file creation/modification/deletion. In the case of the file creation, the ‘action’ attribute value is defined by ‘FileCreated’, in the case of the file modification, the ‘action’ attribute value is defined by ‘FileModified’, and in the case of the file deletion, the action ‘attribute value’ is defined by ‘FileDeleted’. The ‘contents’ attribute value is the created/modified/deleted file name and the ‘detail’ attribute value is a path name in which the file is positioned.

The data filter 120 serves to filter or collect the specific fields or attributes from the respective primary data table 101 so as to newly create a secondary data table 103. For example, as shown in FIG. 11, the specific fields or attributes may be selected from the system start/end data table, the web visit data table, the file search data table, the USB connect data table, the process execution data table, the document deletion data table, and the file deletion data table, as illustrated in FIGS. 2 to 10 to newly create the secondary data table 103.

FIG. 11 exemplarily illustrates a secondary data table created by selecting specific fields or attributes from at least one data table in accordance with the embodiment of the present invention.

In FIG. 11, a section shown by reference numeral 201 is tables for visualizing the specific field, that is, only the data in the specific time zone. In addition, a section shown by reference numeral 203 is a table which may be used for visualization by extracting the specific attributes, that is, only the data corresponding to the specific ‘action’. In addition, a section shown by reference numeral 205 may be used for visualization by extracting only the data corresponding to the user desired specific keywords. As such, the data table includes a unique attribute for efficiently representing raw data, wherein each attribute has a unique format. When a standardized format of data table is created, the visualization can be represented from the data table using various methods. The data table may be represented by a simple arranging representation and a graph representation.

Further, the data table can search and represent only data satisfying specific conditions through interaction with a user. Further, the data table can search and represent only data satisfying specific conditions through interaction with a user.

In addition, the data table may have a file format such as txt, csv, and xls. As a result, the data table can use the file format by importing the file format to an input of a commercial or public data forensics tool.

The data relation analyzer 130 serves to analyze the relation between the data in the first table 101 so as to newly configure another secondary data table 105. For example, the data relation analyzer 130 analyzes the web page having the high visit frequency, the USB connect recording after modifying the document at the same date, the USB connect recording after using the messenger and searching the file, or the like, and may visualize them. The information may be considered as evidence that there is a possibility of the leakage of the document. As such, the visualization for the data relation representation may be implemented by the system configuration.

As set forth above, the embodiment of the present invention can perform the visualization representation from the standardized format of the data table using various methods by creating the standardized format of the data table so as to intuitively and efficiently perform the visualization representation from the raw data collected from the live data forensics tool or the portable forensics tool.

For example, the related art shows the web visiting recording and the document access recording through each window or tap, but when the web visiting data table and the document access data table in accordance with the embodiment of the present invention are present, each of the web visiting recording and the document access recording for all the collection dates can be shown, only the specific date period can be represented, and the recording including the specific keyword can be represented.

Further, the visualization can be represented by various types such as the arranging type, for example, the excel format, the network type representing the correlation, and the tree type, or the like, and the completely new data can be represented by creating the new data table from at least two data table. In addition, the text-based forensics data representation can be implemented by the graphic-based visualization representation from the data table in accordance with the embodiment of the present invention. Therefore, the embodiment of the present invention can derive various visualization modeling for the plurality of data and the relation between the plurality of data and efficiently understand the relevant data, trends, or patterns for the specific phenomenon.

While the invention has been shown and described with respect to the preferred embodiments, it will be understood by those skilled in the art that various changes and modifications may be made without departing from the scope of the invention as defined in the following claims.

What is claimed is:

1. An apparatus for creating a data table of a forensic data, the apparatus comprising:
a data parser configured to create primary data tables including unique attributes of the predetermined keywords by parsing the raw data having different formats for each forensics tool, each attribute having a unique standardized format.

2. The apparatus of claim 1, further comprising a data filter configured to filter specific fields or attributes from the primary data tables to newly create secondary data table.

3. The apparatus of claim 1, wherein the primary data tables includes a system start/end data table, a web visit/search/account data table, an USB connect data table, a processor execution data table, a command execution data table, a file search data table, a messenger data table, a document creation/modification/deletion data table, and a file creation/modification/deletion data table.

4. The apparatus of claim 1, further comprising a data relation analyzer configured to analyse a relation between the data within the primary data tables to newly create secondary data tables.

5. A method for creating a data table of a forensic data, the method comprising:
generating primary data tables including unique attributes of the predetermined keywords by parsing the raw data having different formats for each forensics tool, each attribute having a unique standardized format.

6. The method of claim 5, further comprising:
filtering specific fields or attributes from the primary data tables to newly create secondary data table.

7. The method of claim 5, wherein the primary data table includes a system start/end data table, a web visit/search/account data table, an USB connect data table, a processor execution data table, a command execution data table, a file search data table, a messenger data table, a document creation/modification/deletion data table, and a file creation/modification/deletion data table.

8. The method of claim 5, further comprising:
analyzing a relation between the data from the primary data table to newly create secondary data table.
